(19) United States
(12) Patent Application Publication
(10) Pub. No.: US 2004/0104845 A1
(43) Pub. Date: Jun. 3, 2004

(54) System, Method, and Product for Derivative-Based Wagering Racing Application

(75) Inventor: Robert J McCarthy, Everett, MA (US)

Correspondence Address: ROBERT J. MCCARTHY, 28 HATCH ST, EVERETT, MA, 02149, US

(73) Assignee: TKS, INC., Everett, MA (US)

(21) Appl. No.: 10/604,451

(22) Filed: Jul. 22, 2003

Related U.S. Application Data
(63) Continuation-in-part of application No. 09/027,430, filed on Feb. 20, 1998, now Pat. No. 6,204,813.
(60) Provisional application No. 60/399,656, filed on Jul. 31, 2002.

(51) Int. Cl. G01S 3/02

(52) U.S. Cl. 342/463

(57) ABSTRACT

A computer-based data processing system is described that employs at least one remote sensing device or system capable of providing time-indexed 2D or 3D spatial location, and subsequently uses the location data and other measured or derived data to automatically detect, identify, extract and characterize performance features and outcomes for the purposes of derivative-based wagering and gaming. This patent describes a wagering model and user interface application which is in part similar to derivative-based financial securities trading, with specific application to sports wagering by employing real-time spatial tracking capability. A specific use of the present invention is to extend the presently established pari-mutuel wagering and totalisator systems used for thoroughbred horse racing. Additionally, the present invention has similar application to other sports as well as other performance-based events.

### CROSS REFERENCE TO RELATED APPLICATIONS

The present application is a continuation-in-part of U.S. patent application Ser. No. 09/027,430, filed Feb. 20, 1998, now U.S. Pat. No. 6,204,813, issued Mar. 20, 2001, entitled LOCAL AREA MULTIPLE OBJECT TRACKING SYSTEM, which is commonly-owned and is incorporated herein by reference in its entirety for all purposes. The present application also claims priority to and benefit of U.S. Provisional Application Ser. No. 60/399,656, filed Jul. 31, 2002, entitled SYSTEM, METHOD, AND PRODUCT FOR DERIVATIVE-BASED WAGERING RACING APPLICATION, which is incorporated herein by reference in its entirety for all purposes. The present application is being filed concurrently with another commonly-owned co-pending application, which claims priority to U.S. Provisional Application Ser. No. 60/397,295, filed Jul. 22, 2002, entitled SYSTEM, METHOD, AND PRODUCT FOR AUTOMATED WORKOUT ASSESSMENT OF ATHLETIC PHYSICAL TRAINING, and which is also incorporated herein by reference in its entirety for all purposes.

### BACKGROUND OF INVENTION

The present invention relates generally to athletic performance based gaming, and more specifically to the application of horse racing pari-mutuel wagering. In particular, the present invention establishes the utility of extending present pari-mutuel wagering systems and other gaming applications to include conditional and derivative based wagering in a model analogous to financial securities derivatives and options trading.

The history of horse racing worldwide dates back many centuries with various formats and segmentations, and horse racing was introduced in North America as early as the 1600s. During the 1700s and 1800s in the United States, horse racing continued to evolve as an industry and became more organized, particularly as thoroughbreds became a recognized breed in the late 1800s, and notably in 1873 with the creation of the American Stud Book and in 1894 with the formation of the Daily Racing Form and The Jockey Club. These events and institutions, together with advances in technology for video distribution and wagering information services, have had profound influence on the industry throughout its history.

Presently in North America, as well as in many parts of the world, governance of the horse racing industry is legislated regionally by individual states and provinces. A widely adopted legal form of wagering related to horse racing is pari-mutuel wagering, wherein cash payouts result from a pooling of the total of all bets placed (i.e., wagering handle) for a particular race up until the start of the race (i.e., post-time). Payout values are determined by pricing calculations to balance the betting pool (“book”) through adjusting the payout odds based on actual wagering volume for various possible outcomes, while explicitly accounting for a fixed industry takeout based upon local regulations governed by the individual state racing commission in each region. In general, industry takeout ranges from 15%-30% depending on the type of wager, and is split between the participants (host racetrack providing the signal and the site or distribution channel wagering on the signal) and taxes. Thus, for profitability, the takeout after taxes is expected to cover the source track operating costs, horsemen's purses, media production and simulcast distribution costs, as well as any overhead costs related to providing the wagering services and related offerings to the consumer.

Pari-mutuel wagering was developed in the mid-1800s in France by Joseph Oiler, who is credited with inventing and standardizing the rules for this type of gaming. Oiler was issued the first totalizer patent in 1868 and his systems were subsequently used throughout France thereafter. In the 1930s pari-mutuel wagering was legalized in California and New York, and subsequently followed by many other states and provinces in North America. With the predominant (or only) legal form of wagering on horse racing in North America being pari-mutuel, several established companies now provide totalizer services to the industry (note: totalizer, or totalisator, is more commonly referred to as “tote” systems/services). In particular, these companies include Autotote (Scientific Games), Amtote, and United Tote (Anchor Gaming/IGT). Together with a network of simulcast providers that distribute live racing video signals from over 100 racetracks via satellite to over 1000 outlets in North America, and with the various media companies that deliver televised coverage of live racing, these various organizations provide the basis for the industry's market offerings to consumers.

During the past several decades, advancements in technology have made many substantive impacts on the sport and its consumption, both in the form of media distribution to fans and entertainment gaming/wagering for bettors. Examples include satellite-based simulcast video distribution, modern distributed information systems (transactional processing, database storage systems, etc.), online account wagering, and sophisticated handicapping tools. For horse racing wagering applications, it is anticipated advances in technology, particularly for developments related to information systems, will continue to have substantial impact on the industry, especially related to the wagering aspects of the industry.

Pari-mutuel wagering can be segmented into two categories: (i) basic wagers on a single selected horse to win (1st), place (2nd or better), or show (3rd or better), and (ii) exotic wagers which are combinational bets that include composite outcomes for multiple horses in the same race. Some examples of exotic wagers presently available at many racetracks include the exacta, quinella, superfecta, and pick-six, among others (references on these and other types of exotic wagering are well understood and widely available and are not presented herein). All wagering formats, pari-mutuel or otherwise, depend on accurate and timely information for timing and scoring. Various systems, methods, and techniques exist in the industry today for generating the timing and scoring information data from races (and workouts) used for wagering results and handicapping tools.

Present methods of timing and scoring data collection for sports applications lack many advantages available through modern technology (e.g., optimal state estimation and tracking, multivariable control systems, etc.). In general, athletic timing and scoring systems rely on manual recording and data collection techniques, and in many cases use only very basic technological assistance like binoculars, video tape recorders, stop watches, etc. In some cases, other technologies such as photo-eye beam or photo-finish systems may be available, but often lack the ability to distinguish ambiguities among multiple objects (especially between fixed observation points, e.g., at the ⅛-mile poles of a racetrack). These established systems and conventional methods for timing and scoring are often prone to human error and measurement processing error, and in some cases may even result in erroneous identification of the individual athlete, animal, or other object being assessed.

Recognizing the increasing capability and availability of suitable modern remote sensing devices, efficiencies from commercially-available modern data capture techniques, and trends in related data processing and information system technologies, the present invention seeks to establish a novel extension of presently available exotic wagering models employed by the gaming industry.

The present invention focuses on one aspect of novel advancement to be considered for the horse racing industry (and related sports) the ability to extend present wagering models to include a broader range of exotic wagers based on unique combinations and/or future information. This invention describes real-time spatial-tracking technology and its particular utility related to the extension of established exotic pari-mutuel wagering models and methods, and describes a category of exotic wagers that can be played prior to the start of a race (or during a race) with formulations and payout determination models that include future in-race events. As such, this new category of wagers is characterized as derivative-based wagering (with application to racing as well as other sports) analogous to financial securities derivatives trading in the sense that the new category of wagers all share the commonality of being combinational bets (as with established exotics). However, unique to this invention and the spatial tracking system and methods described herein, these combinational wagers are extended from basic combinations of final race outcomes to more sophisticated combinational models that can include mid-race temporal events and relative spatial geometries (e.g., by specifying conditional triggers such as relative differences in timing or a designated threshold on spatial separation within a certain segment of the race, etc.).

By way of comparison and illustration, the ability to spatially and un-ambiguously track the full-field of horses during a race with high accuracy and fidelity in real-time, as described in U.S. Pat. No. 6,204,813 or by using a tracking system or methodology substantially similar in form or function, would enable a broad range of market offerings to the racing industry. Such applications would range from basic enhancements to tabulated past-performance handicapping data, to fully-animated recreations of live races, to sophisticated multi-dimensional stochastic and predictive simulations to indicate statistically-distributed outcomes given parameterized models for past performance, track conditions, weather, etc. Additionally, such data would also serve as the basis for a wealth of opportunities related to new wagering and gaming applications for the racing enthusiast.

In particular, the present invention discloses a system and methodology that enables extending present methods in exotic wagering to include derivative and conditional wagering, e.g., defining combinations and triggered options along with models and procedures for related preferred embodiments. In general, the preferred embodiment of the present invention, as described herein, enables the wagers to be placed a priori, i.e., prior to post-time, consistent with existing methodologies presently employed in practice, however, the actual implementation and the scope of the invention need not be limited as such. Additionally, the present invention establishes a means for relating and integrating the expanded set of derivative wagers to the established models and systems presently used in the industry.

Prior art has been established in related areas. In particular, various methods have been presented for generating timing and scoring information related to horse racing during actual races. The present invention overcomes limitations in the prior art by introducing a system and methodology to automate comprehensive full-field quantitative assessment throughout a race. The described approach employs the novelty of quantitatively capturing athletic performance during races, such as with the local area multiple object tracking system described and referenced herein (see U.S. Pat. No. 6,204,813), or by utilizing one or multiple (individual or integrated) other suitable technologies with substantially similar measurement capabilities. Once a digital record of the race is available, the extension of established pari-mutuel wagering systems as presented herein is readily enabled.

Particular examples of related prior art for capturing timing information include: impulse radio (U.S. Pat. No. 6,504,483); event recording with a digital line camera (U.S. Pat. No. 5,657,077); cinematographic camera directed at finish line (U.S. Pat. No. 4,523,204); and, a transmit/receive device using sum and difference signals to detect when an object passes the finish line (U.S. Pat. No. 4,274,076). These examples all lack specific techniques, methods, and procedures for automating the unambiguous and comprehensive quantitative assessment of live races for full fields of entrants, as described by the present invention.

Additionally, prior art has been established in the specific area of pari-mutuel wagering, and in particular pari-mutuel wagering as specifically related to horse racing. Particular examples include: methods and apparatus for pari-mutuel historical gaming (U.S. Pat. No. 6,450,887, U.S. Pat. No. 6,358,150); casino/lottery/sports styled wagers and games for pari-mutuel racing operations (U.S. Pat. No. 6,309,307); interactive wagering systems and processes (U.S. Pat. No. 6,554,709, U.S. Pat. No. 6,554,708, U.S. Pat. No. 6,099,409, U.S. Pat. No. 6,089,981, U.S. Pat. No. 6,004,211, U.S. Pat. No. 5,830,068); combined totalizer and fixed odds betting system and method (U.S. Pat. No. 5,672,106); system and method for wagering at fixed handicaps and/or odds on a sports event (U.S. Pat. No. 5,573,244); and, combined fixed price and expected dividend betting system (U.S. Pat. No. 4,775,937).

Established prior art, however, lacks specific models, techniques, and procedures for extending the presently established gaming methods to include extensions to conditional wagering, derivative-based gaming, or other advanced practices as described herein. The utility and desirability of such gaming extensions to present systems can be compared to the extension of basic conventional wagers (i.e., win, place, show) to presently established exotic wagers (e.g., exacta, superfecta, pick-6), or in a broader context, it can be compared to the extension that derivatives and options trading have effectively introduced to the financial securities markets (e.g., put/call contracts, bermuda options, or other exotics).

Thus, the particular novelty and utility of the present invention, especially as related to and in comparison with the prior art, resides primarily in its capability to provide a systematic basis for automating the quantitative assessment of athletic physical performance for the purposes of extending established methods in pari-mutuel wagering applications. Moreover (as mentioned previously), the described system and methods are also suitable to provide similar benefit to other athletic training and contests, such as, but not limited to, track and field events, motorsports, water sports, other terrain-based races, Olympic contests, road races, and marathons, at least to the extent that such events support wagering and gaming applications. A primary benefit of the system is the extension of existing models for wagering and gaming enabled by the accuracy of real-time spatial tracking data, efficiency of operation, and remote unambiguous identification of in-race situational conditions.

### SUMMARY OF INVENTION

It is therefore a principal object of this invention to provide a system and methodology for automating the quantitative assessment of training related to athletic performance, with utility to animals, human athletes, and/or other objects, based on real-time dynamic spatial tracking data (and related derived data attributes and information systems) for the purposes of timing and scoring as related to derivative and conditional wagering, gaming, and other similar entertainment applications.

It is another principal object of this invention that said system and methodology comprise capability to process, store, retrieve, interface, and/or present over various media formats the spatial tracking measurement data and associated derived data attributes.

It is yet another principal object of this invention to describe the utility of said system and methodology for specific application to pari-mutuel wagering systems including specifically the extension of said systems to include conditional and derivative-based wagering applications. Such applications might include, but not necessarily be limited to, wagers placed prior to post-time but conditioned (or “triggered” based on a future parameterized event occurance (e.g., a selected horse leading at a particular point of the race, or one horse leading another horse by a minimum specified distance or time interval, etc.).

It is yet another principal object of this invention to provide the ability to present results by employing various media formats including, but not limited to, printed hardcopy, computer-generated hypertext, synchronized graphic overlay with video, or animated visual recreation presented over wireless device.

It is yet another principal object of this invention to further comprise a data storage subsystem, integrated locally and/or accessible remotely over a computer network or via the Internet, so as to facilitate an ability to present comparisons of odds and payout information for these extended applications, and optionally to present such results in conjunction with present and past performance handicapping data.

It is yet another principal object of this invention to describe a set of preferred embodiments for the presentation of said system and methodology for end-users, and in particular, an interactive multimedia application with real-time animated motion-graphic rendering accompanied by audio sound bites and individualized user preferences.

It is yet another principal object of this invention to describe a method and its utility to determine risk-adjusted and cost-effective payout model(s) for said derivative and conditional wagering applications.

Accordingly, the present invention features a combination of computer programs and functionality that together implement a set of executable procedures to provide conditional and derivative-based wagering based on dynamic spatial tracking data.

With modern dynamic spatial tracking technology, such as the system and method presented in U.S. Pat. No. 6,204,813, the additional fidelity of data collection can be employed for many novel advances in automating data processing and event feature recognition for the purpose of enhancing and extending athletic performance based wagering and gaming, e.g., application to horse racing pari-mutuel wagering. In Thoroughbred horse racing where pari-mutuel wagering is a fundamental aspect of the entertainment value of the sport, for example, derivative-based wagering could include placing a typical outcome-based wager dependent on the situation at the mid-point of the race (or any other variation thereof). Such a wagering system would enable participants to extend their knowledge and speculation using handicapping information to a more elaborate model. Using modern tracking technology to associate spatial location with changes in speed, detection and recording of intra-race conditions can be automated using the approach described herein.

Continuing with the horse racing application to further illustrate the utility of the present invention, typical races include point-of-call data collected by chart callers (and/or trainers, assistants, handicappers, or in some cases, broadcast media technicians), who either independently or together collectively determine the identity of horses based on program information, saddlecloth color and number, and/or other physical characteristics, then visually detect and manually record the start and finish times and locations of individual horses travel around the racetrack. This process is generally limited to a select number of lead horses only (typically four, due to its labor intensive operation).

Using the technology described in U.S. Pat. No. 6,204,813 B1 (FIG. 1), or a technology similar in function or measurement capability, a derivative model may be employed to enable wagering or gaming applications wherein the user can place a bet on the final outcome dependent upon the situational conditions throughout a race. Of course, the derivative model is extendable to other athletic contests beyond racing (e.g., placing a wager a priori on the final outcome of a football game triggered by who is ahead at the half, or an election poll prior to official results, or other news event). As with financial securities options (a special case of financial securities derivatives), the implementation may or may not include a premium to be paid in order to place the derivative-based wager.

As such, the present invention establishes that with the availability of a full digital record of a live race, available in real-time and replay archive, that wagering systems can be extended to include conditional parameters, e.g., mid-race triggers and/or other exotic wagers that rely on situational information prior to final outcome. By way of illustration only, using the model of present invention, one could place a 2,7 exacta bet conditioned upon the 2-horse leading at the 3-pole with a specified distance and/or time interval, where the wager is placed a priori (before post-time) and triggered only if the conditional qualifier is satisfied.

Pricing models for such advanced gaming and wagering scenarios are well established in the financial securities markets with derivatives and options trading. Thus, the present invention describes using a pricing model similar to those of the financial markets wherein the conditional wager is played with an upfront premium, and the premium would be forfeited if the conditional qualifier is not triggered. The present invention describes the utility of such wagering application extensions in the context of using full-field real-time spatial tracking data to serve as the basis for the described derivative-based wagering application(s) for the purpose of substantially enhancing the gaming experience for spectators, fans, handicappers, and players.

The preferred embodiment of the system includes integration with the technology described in U.S. Pat. No. 6,204,813, or a technology substantially similar in function and/or measurement capability.

### BRIEF DESCRIPTION OF DRAWINGS

FIG. 1 provides a block diagram overview of spatial tracking technology suitable for providing measurement data for automated workout assessment of athletic physical training.

FIG. 2 illustrates a sample system installation at a racetrack.

FIG. 3 presents a graphical depiction of a sample user interface to submit wagers as an extension to presently existing models and applications in the industry.

FIG. 4 illustrates a sample wireless animated visual presentation application with examples of feature/attribute enhancements uniquely enabled by spatial tracking capability.

### DETAILED DESCRIPTION

In one embodiment, the present invention features a radio frequency (RF) positioning system that determines the identity and positional data such as location, velocity, and acceleration of numerous objects. The system includes a plurality of spread spectrum radio transceivers where at least one transceiver is positioned on each object. Using spread spectrum radio transceivers is advantageous because it allows unlicensed operation.

At least three spread spectrum radio transceivers transmit to and receive signals from the plurality of radio transceivers. The at least three spread spectrum radio transceivers may employ directional antennas. Also, a processor may be electrically coupled to the at least three spread spectrum radio transceivers. The processor determines the time of arrival of signals received by the spread spectrum radio transceivers.

A signal processor is coupled to the spread spectrum radio transceivers. The signal processor determines the identity and positional data of the objects. The signal processor may determine at least one of: position; time derivatives of position; orientation; and time derivatives of orientation. The signal processor may be connected to the spread spectrum radio transceivers by any network, such as an Ethernet, fiber optic or wireless network.

A memory may be used to store the identity and the positional data of the objects. A video processor may be used to display the identity and the positional data of the objects on a video display terminal. In addition, the RF positioning system may include a database engine for storing and retrieving data relating to the objects. The data may include biographical data of players in a game such as physical characteristics (height, weight, and strength and speed metrics) and previous game statistics. The video processor can display the data relating to the objects separately or together with the identity and the positional data of the objects.

The present invention also features a method of determining identity and positional data of numerous objects in a three-dimensional space. The method includes providing a plurality of spread spectrum radio transceivers where at least one transceiver is positioned on each of the numerous objects. The method also includes providing at least three spread spectrum radio transceivers. The method may include instructing the spread spectrum radio transceivers to transmit a spread spectrum signal that instructs a particular one of the plurality of spread spectrum radio transceivers to transmit a signal that can be processed to determine identity and positional data of the transceivers.

Signals are received from at least one of the spread spectrum radio transceivers with the spread spectrum radio transceivers. A signal processor is provided that is coupled to the spread spectrum radio transceivers. The signal processor de-spreads the signals to determine the identity of the objects and processes the signals to determine the positional data of the objects. The positional data may be at least one of: position; time derivatives of position; orientation; and time derivatives of orientation. The positional data of the objects may be determined from estimates of the times of arrival of the signals to each of the at least three antennas. The times of arrival may be measured relative to a synchronization clock.

The method may include storing the identity and the positional data of the objects. The method may also include displaying the identity and positional data relating to the objects on a video screen. Information specific to the objects may also be displayed on the video screen.

The present invention also features a system for monitoring the performance of sports players on a sporting field. The system includes a plurality of spread spectrum radio transceivers where at least one transceiver is positioned on each of a plurality of sports players. The plurality of spread spectrum radio transceivers may be positioned proximate the sports player's center of mass. Sensors may be positioned on the sports players and electrically coupled to the transceivers. The sensors may comprise one or more motion sensors such as impact, acceleration, or gyro sensors. The sensors may also comprise one or more non-motion sensors such as physiological sensors.

At least three spread spectrum radio transceivers are positioned proximate to the sports field. The spread spectrum radio transceivers transmit to and receive signals from the plurality of radio transceivers. A signal processor is coupled to the spread spectrum radio transceivers. The signal processor determines the identity, positional data, and related quantitative measures of performance of the sports players.

Using measurement data provided by the RF system, in particular the spatial tracking data, one skilled in the art can calculate various application-specific metrics. In addition to timing measurements, these metrics include, but are not limited to impact, total distance, directional distance, quickness, average speed, and vertical leap. The results from calculating these or other related metrics can be presented to the user in numerous ways. For example, the metrics may be presented as numerical data, graphical data, light intensity, color, physical force or sound.

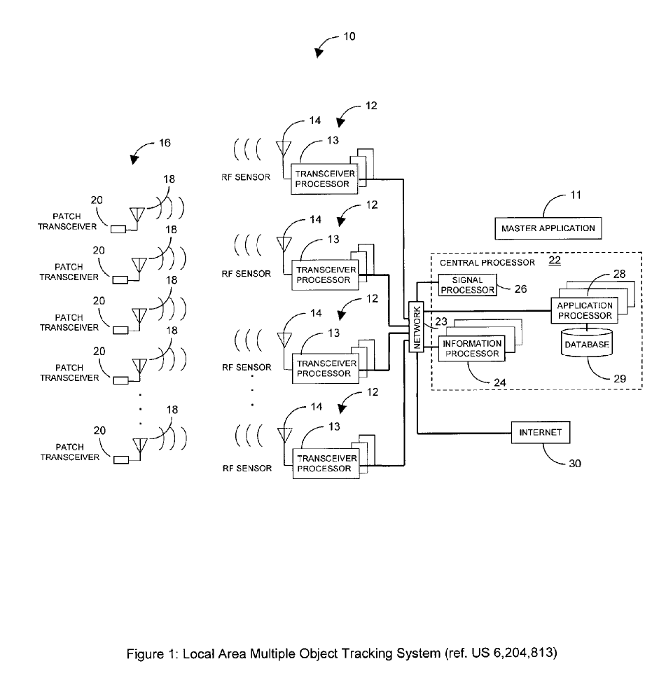

FIG. 1 provides a schematic block diagram of the local area multiple object tracking system 10 embodying the invention. The spatial tracking capability provided by the system is particularly suitable for providing measurement data for the derivative-based wagering applications as described by the present invention. The system 10 tracks the spatial locations of multiple objects simultaneously and determines location, velocity, and acceleration vectors. In one embodiment, the system 10 tracks thoroughbred horses during a race or workout.

The tracking system 10 may include a master application 11 that controls and monitors the system 10. The tracking system 10 includes at least three tower transceivers 12 (also referred to as perimeter transceivers for racing applications). Each of the tower transceivers 12 includes processors 13 and antennas 14. The tower transceivers 12 are located surrounding a local area such as a playing field or a racetrack. The tower transceivers 12 may be movable. Additional tower transceivers are used if objects become obscured as they move through the local area. Using additional tower transceivers improves accuracy and also extends battery life since lower transmitter powers can be used. In order to track objects in three dimensions, more than three tower transceivers 12 are typically used.

The antennas 14 transmit electromagnetic energy generated by the tower transceivers 12 to and receive electromagnetic energy from the objects being tracked. The antennas 14 are typically positioned around and above the local area and the objects being tracked. Such positioning is advantageous because it reduces signal interference caused by the objects being tracked. If three-dimensional positional data is required, the antennas 14 may be positioned in at least two different planes.

The antennas 14 may be directional antennas. In one embodiment, the antennas 14 may be directional with 90-degree azimuth and 90-degree to 0-degree range elevation coverage. Using directional antennas is advantageous because the directionality improves signal rejection of multi-path signals. The antennas may be mechanically or electronically rotated or steered. Additional position information or directionality can be obtained by steering the antenna's main lobe. The antennas 14 may also be mobile. The position of the antennas may be known relative to a fixed object or may be located with another system such as GPS or a laser site system.

Object patch transceivers 16 are attached to each of the objects being tracked (not shown). Antennas 18 are electrically coupled to the object patch transceivers 16 for transmitting to and receiving signals from the tower transceivers 12. The antennas 18 may be hemispherical pattern antennas that are integrated into the object patches. For example, the antennas 18 may be microstrip line patch antennas that conform to surfaces such as a player's helmet, a jockey's helmet, vest, or armband, or other athletic equipment. A processor 20 is coupled to each of the object patch transceivers 16 for processing the received signal. The object patches 16 may be remotely reconfigurable. For example, the object patch's code and code length may be remotely programmable. The object patches may also incorporate remote testing capability.

Each of the tower transceivers 12 are coupled to a central processor 22 by a network 23. The network 23 may be any high-speed communication network such as a wireless link or Ethernet. The central processor 22 includes an information processor 24, a signal processor 26, and an application processor 28. The central processor 22 may include a database engine 29 for storing and retrieving data about the objects being tracked. For example, the data may represent past movements or statistical data about the object being tracked. This data may be accessed by a video processing system and converted into graphic images or animations. The video processing system can display the data separately or together with video of the objects. The central processor 16 may employ algorithms to create animation or graphs. The data may also be made available to the Internet 30 so that it can be distributed throughout the world.

In operation, the processors 13 in the tower transceivers 12 determine the times of arrival of the signal received from the object patches 16. From the times of arrival and from knowledge of the location of the tower transceivers 12, the central processor 22 determines the location, velocity, and acceleration (LVA) of the objects. In one embodiment, the tower transceivers 12 move along with the objects being tracked. In this embodiment, the position of the tower transceivers 12 along with the times of arrival are sent to the central processor 22 to determine the LVA of the objects. The central processor 22 generates numerical and graphical representations of LVA for each of the players.

The central processor 22 may also determine various performance metrics from the positional data and from sensor data transmitted by the object patches 16. In one embodiment, accelerometer and gyro data are also transmitted by the object patches. The central processor 22 may merge the LVA data with data in a database such as a sports specific database. Certain performance metrics such as a “sprint detector” 100 may be calculated from the merged data.

Numerous techniques are used to separate the signals from each of the objects. In one embodiment, the object patches 16 are programmed with a time division multiple access (TDMA) time-slot. In other embodiments, the object patches 16 are programmed with frequency division multiple access (FDMA), code division multiple access (CDMA), or spatial diversity multiple access (SDMA). Combinations of these techniques can also be used. In one embodiment, the object patch 16 and tower transceivers 12 transmit and receive 2.4 GHz carrier signals that are binary phase shift key (BPSK) modulated with a pseudo-random noise (PRN) code.

In one embodiment, the object patches 16 transmit their code during an assigned time slot using direct sequence (DS) spread spectrum. Using spread spectrum codes is advantageous because multiple objects can use the same time slot and because it allows unlicensed operation. Frequency diversity schemes may also be used in situations where a single frequency is not reliable enough. The tower transceivers 12 are programmed with a list of object identifications and their corresponding TDMA time slots. The tower transceivers 12 listen during the appropriate time slot for each of the objects and, if an object patch signal is detected, the processor 13 determines the object's identification code and measures the signal's time-of-arrival (TOA) to the respective tower transceiver antenna 14.

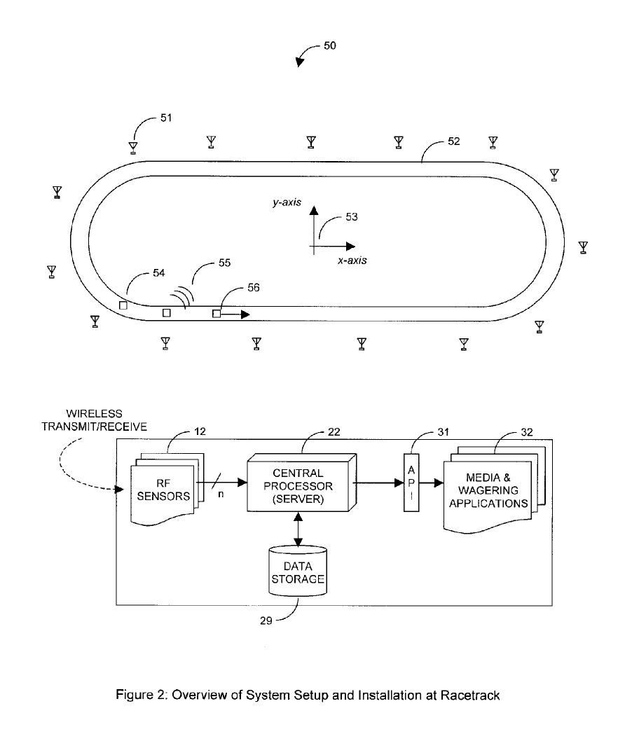

FIG. 2 illustrates a sample system installation at a racetrack, including RF sensors 12 (tower transceivers), a Central Processor (Server) 22, Application Programming Interface (API) 31, and various media applications 32. This embodiment, as presented in FIG. 2, is intended to augment and/or replace present methods for chart calling used throughout the industry. The most common present method employed for collection of timing and scoring data during races is to use individuals referred to as chart callers (typically two at each racetrack) to manually document the events of the race by visually identifying the running order and marginal distance intervals among the field of horses at designated points of call around the racetrack (generally every ⅛ mi). Following the race, point-of-call data is combined with information from other systems (e.g., photo finish, video replay, tote systems, and other related information systems), and chart callers will generally write a race narrative to accompany the official database archive for later use.

Various methods, sensor devices, and systems have been attempted previously to automate much of the data collection process with very limited success. Examples include video/image processing, inductive loops, and radio frequency transponders, among others, but all have been met with challenges related to practical in-situ operation that have not been overcome to date. Generally the technical limitations include: (i) multipath and/or other forms of interference, (ii) lack of reliability for resolving identity ambiguity during partially or fully blocked line-of-sight, (iii) limitations due to impaired operation during non-ideal weather and environmental conditions, and/or (iv) comfort and safety acceptance for the physical packaging of the radio tag device electronics. The system presented in FIG. 2, however, has been deployed and integrated successfully during live races at a major North American racetrack with full-field real-time race coverage with un-ambiguous spatial tracking data and related media applications.

In this particular embodiment, as presented in FIG. 2, the central processor 22 includes an information processor 24 that determines the position information from the TOA estimates provided by the tower transceivers 12. The position of the objects or players in the local area is determined from the time-difference-of-arrival (TDOA) of at least three pairs of antennas by using a transform operator that uniquely solves the set of simultaneous inequalities describing the TDOA measurements between all unique antenna pairings. These equations can be solved in closed form after linearization or by predetermined table lookup. The accuracy of the position estimates can be improved by taking multiple measurements and using least squares estimation and weighting techniques or other established optimal estimation techniques known in the art. Also, estimates of previous TDOA for each pairing may be used to improve accuracy by techniques known in the art.

An additional indicator of the object's position can be derived from the signal levels received by the tower transceivers 12. As the object patches 16 move away from the tower transceivers 12, the signal level received by the tower transceivers 12 will drop approximately proportional to the square root of distance between the tower transceivers 12 and the object patches 16. Errors in the square root dependence can be compensated for mathematically.

If the transmitted power is known or can be inferred, the signal levels received by the tower transceivers 12 are an indication of the object's position. Alternatively, if the transmitted power is not known and if the object patch antennas 18 are omni-directional, positional data can be obtained from constant delta signal level curves derived from the difference in signal levels received by all possible pairings of tower transceiver antennas 14. For directional antennas, the above techniques along with knowledge of the antenna pattern is used to determine the positional data.

The information processor 24 may also determine acceleration and rotation from sensor data. A second information processor 24″ processes the position information determined by information processor 24 into location, velocity, and acceleration (LVA) estimates for the objects. The second information processor 24″ implement various adaptive digital filters employing Kalman techniques.

The central processor 22 also includes an application processor 28 that processes the LVA estimates and presents them to the user along with data from an object database. In one embodiment, the application processor 28 is configurable in real time (on-the-fly) so that the presentation to the user of the LVA estimates and the data from an object database can be modified on demand. The application processor 28 also identifies maneuvers (i.e. specific plays in a game such as football) and object birth and death events such as a player coming onto or leaving a playing field. Maneuver identification is used to dynamically reconfigure the system and optimally assign processing resources. The central processor 22 may also include a database engine for storing and retrieving information about the objects.

From the LVA estimates, one skilled in the art can calculate various application specific metrics. These metrics include impact, total distance/gained distance, quickness, average speed around bases, and vertical leap. The results from calculating the metrics can be presented to the user in numerous ways. For example, the metrics may be presented as numerical data, graphical data, light intensity, color, physical force or sound.

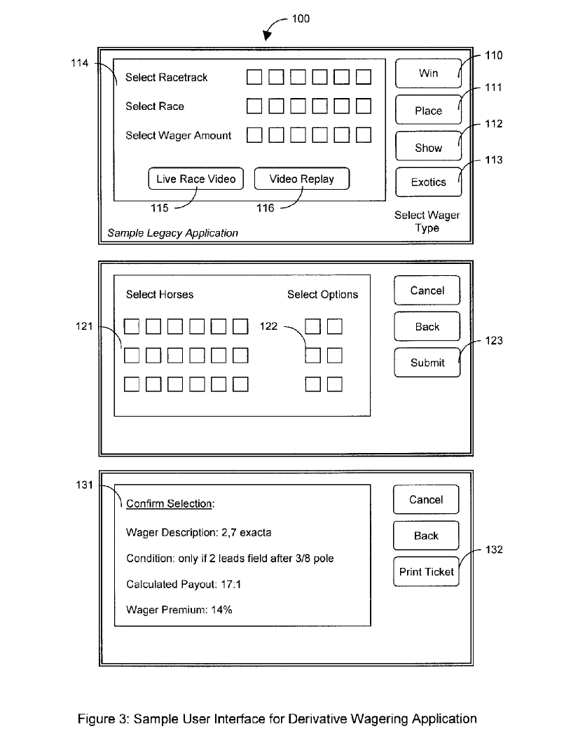

FIG. 3 presents a graphical depiction of a sample interface to submit derivative wagers as an extension to presently existing models and applications in the industry. The model is representative of derivatives securities trading in the sense that the spatial tracking data enabled the wager to be placed as an option contract. As such, it may include a premium payment for the option to exercise the ability to place the bet after the race starts, or equivalently triggered based upon a mid-race situation. As some historical perspective, trading stock options was manually intensive until the Chicago Board Options Exchange (CBOE) established systematic processes in 1973 to standardizing price listings, which in turn facilitated the ability for investors to compare options contacts and prices as well as broadened the ability to bring together multiple parties to assess and participate in the transactions. With these more automated processes came additional investors and increased liquidity, resulting in a substantial increase in the trading volumes which have continued to grow ever since. It is an intention of the present invention to facilitate a similar result in wagering handle with bettors, reaching an expanded set of demographics for the industry's consumer base.

For example, options trading allows one to place combinational trades wherein downside risk can be hedged without adversely affecting the upside return. Similarly, FIG. 3 illustrates a sample user interface for submitting a wager using a kiosk, wireless, or other device-based application, enabling users to submit derivative wagers related to spatial tracking information in a highly similar manner to other exotic wagers presently available in the industry. The user selects 114 a racetrack, race, and wager amount. The application may or may not be integrated with other user features like video replays 115 for reviewing horse performances from earlier races, or it may allow for viewing the live race 116. Standard bets are available, including win 110, place 111, and show 113, as well as the exotics category 113, which the user would select if wishing to place a derivative or conditional wager. A second screen appears in which the user selects a horse 121 and the options 122 for the wager. For example, the user might select the number 2 horse to win if it's leading the field by more at least 1 length (or 8.5 feet) at the ⅝-pole. Each of the conditions is selected and quantified by the user through a series of sequential user inputs. When the user finishes entering the desired wager and optional conditions, the wager is then submitted 123, at which point it will be entered into the pari-mutuel wager pool upon confirmation. The confirmation screen displays the wager and conditions and allows the user to cancel or submit the wager with a printed ticket receipt 132.

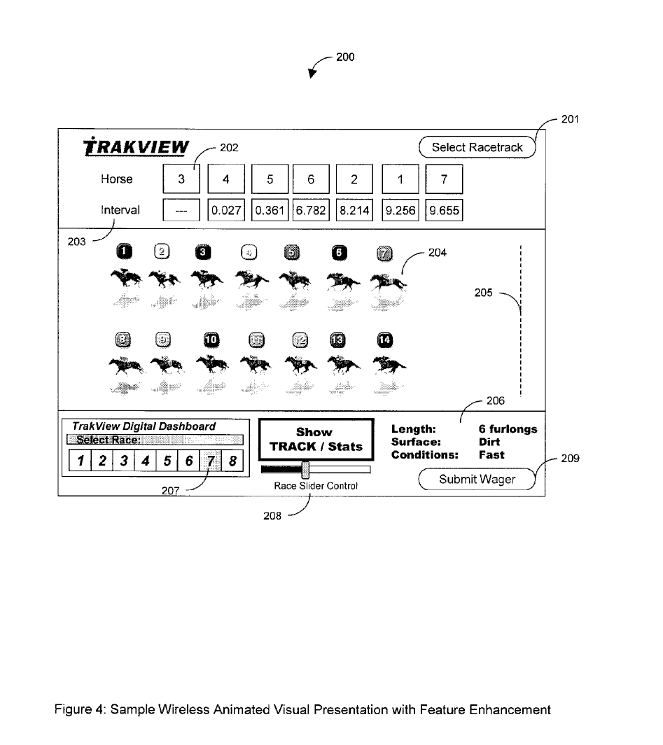

FIG. 4 illustrates a sample animated visual presentation application 200 that may be used to facilitate the submission of derivative wagers and the individualized presentation of the live race and wager outcome. The primary significance and perhaps the most powerful aspect of presenting the race using animation rendered based on spatial tracking data, especially as related to the present invention, is the ability to enhance features on an individual basis to materially affect consumer satisfaction of the race viewing experience. For illustration by way of example, but certainly not limited to such, an example of individualized presentation could include the following scenario: the consumer places a wager on the number 4 horse and during the race the number 4 horse is shown with a halo or other means of highlighting such as a different color (or other horses being shadowed out), thus individually personalizing the race presentation based on pre-defined user preferences or actual wager placed. In relation to the derivative wager example previously used, this presentation might indicate the derivative wager mid-race conditions have been satisfied (e.g., the number two horse is indeed leading by 1 length after the ⅝-pole), and thus the selected horse combination is indicated by a yellow highlight that turns to green to indicate the bet has been triggered.

In the application presentation of FIG. 4, a combination of feature enhancements is illustrated 200. Such an application, or variations thereof, would be suitable for kiosk, Internet, interactive television, or wireless handheld device. Along the header is the racetrack selection 201 and a running order full-field leaderboard 202 that is updated live throughout the race by using the spatial tracking data yielded by the system. Similarly, the interval 203 indicating marginal distance or time between each horse and the leader is shown alongside the leaderboard, making the integrated presentation available for consumers to view individual selections among the field. A live rendered animation 204 of the race with virtual enhancements like the pole markers indicated by reference lines 205 directly inserted into the visual presentation to facilitate the view for users. The footer includes various controls, such as race selection 207, other information commonly available at the racetrack 206 (such as race length, racetrack surface conditions, weather, etc.). Uniquely enabled by spatial tracking data are the view controls 208, wherein the user is able to control perspective (virtual camera orientation) and playback controls (pause, play, rewind all available live, with fast forward available after the race). There are many other features and enhancements that may be included, of course, such as full-view (a top-down view of the full racetrack), many other statistics, past performance and handicapping information, program schedule data, etc.

In addition, although some aspects of the present invention were described with particular position location techniques, the invention may be practiced with other position location systems. For example, other position locating techniques such as radar, other radio frequency systems such as ultra-wideband (UWB) or transponders, satellite imagery, astronomical observations, GPS, accelerometers, video processing, laser reflectometry, directional antennas, moving antennas, and steerable antenna arrays, and/or combinations or hybrids thereof, may be used with this invention.

Having described the preferred embodiments of the invention, it will now become apparent to one skilled in the art that other embodiments incorporating the concepts may be used and that many variations are possible which will still be within the scope and spirit of the claimed invention. Therefore, these embodiments should not be limited to disclosed embodiments but rather should be limited only by the spirit and scope of the following claims.

1. An RF tracking system for determining characteristics of at least one object in a local area, the system comprising:
(a) at least one remote spread spectrum radio transceiver, the at least one remote spread spectrum radio transceiver being coupled to the at least one object in the local area;
(b) at least three tower spread spectrum radio transceivers being positioned proximate to the local area and the at least three spread spectrum radio transceivers transmitting signals to and receiving signals from the at least one remote spread spectrum radio transceiver;
(c) a signal processor coupled to the at least three tower spread spectrum radio transceivers, the signal processor processing signal data received from the at least three tower spread spectrum radio transceivers;
(d) a database engine in communication with the signal processor, the database engine storing in and retrieving from a database the signal data and biographical data relating to the at least one object; and
(e) a processor coupled to the database engine, the processor determining the characteristics of the at least one object based, at least in part, on the signal data and the biographical data.

2. A method for determining characteristics of at least one object in a three-dimensional space, the method comprising:
(a) providing at least one remote spread spectrum radio transceivers, the at least one remote spread spectrum radio transceiver being coupled to the at least one object;
(b) positioning at least three tower spread spectrum radio transceivers proximate to the three-dimensional space;
(c) receiving signal data from the at least one remote spread spectrum radio transceiver with the at least three tower spread spectrum radio transceivers;
(d) coupling a signal processor to the at least three tower spread spectrum radio transceivers, the signal processor processing the signal data received from that at least three tower spread spectrum radio transceivers;
(e) storing in and retrieving from a database the signal data and biographical data relating to the at least one object; and
(f) processing at least the signal data and the biographical data to determine the characteristics of the at least one object.

3. A system for monitoring the performance of at least one sports player, animal, or other object on a sporting field or a racetrack for the purpose of enabling derivative-based wagering, the system comprising:
(a) at least one remote spread spectrum radio transceiver, the at least one remote spread spectrum radio transceiver being positioned on the at least one sports player, animal, or other object;
(b) at least three tower spread spectrum radio transceivers being positioned proximate to the sports field or racetrack, the at least three tower spread spectrum radio transceivers transmitting signal data to and receiving signal data from the plurality of remote spread spectrum radio transceivers;
(c) a signal processor coupled to the at least three tower spread spectrum radio transceivers, the signal processor processing signal data received from the at least three tower spread spectrum radio transceivers;
(d) a database engine in communication with the signal processor, the database engine storing in and retrieving from a database the signal data and biographical data of the at least one sports player, animal, or other object; and
(e) a processor coupled to the database engine, the processor determining the characteristics of the at least one sports player, animal, or other object based, at least in part, on the signal data and the biographical data.

4. A computer-based system compatible with spatial tracking technology consistent with that of claim 3, the integrated system comprising capability to process, store, retrieve, interface, and/or present over various media formats spatial tracking measurement data and associated derived data attributes related to athletic physical performance for the purpose of enabling automated extensions to established gaming and wagering applications, specifically including conditional, derivative, and combinational bets.

5. The system of claim 3 further comprising capability to communicate with, or provide an interface to, existing legacy information systems including tote systems, odds/payouts information systems, infield/in-venue scoreboards, simulcast video distribution to in-venue monitors/kiosks and to remote off-track-betting establishments (OTBs).

6. The system of claim 3 further comprising capability to provide various presentations of results thereof, over various media formats including, but not limited to, printed hardcopy, computer-generated hypertext, interactive animations, and/or synchronized graphic overlay with video.

7. The system of claim 3 further comprising the ability to generate trend analysis, using past and present performance quantification and derivative wagering models as determined by said system and method, to provide simulation results for handicapping purposes to plan and optimize future wagers.

8. The system of claim 3 further comprising the ability to set a user alert or user preference, such that the user can be paged or called back over a wireless communications device, with the live or requested data results formatted and customized for presentation over said device.

9. A method for automating the implementation and tracking of derivative and conditional based wagering by employing spatial tracking measurements as the basis of computer-assisted analysis and presentation of said assessment results.

10. The method of claim 9 further comprising a data storage subsystem, integrated locally and/or accessible remotely over a computer network or via the Internet, so as to facilitate an ability to present comparisons of past performance.

11. The method of claim 9 further comprising a data storage subsystem, integrated locally and or accessible remotely over a computer network or via the Internet, so as to facilitate the ability to present comparisons of past performance and/or previous derivative wager outcomes related to said system.

12. The method of claim 9 further comprising capability to provide various presentations of results thereof, over various media formats including, but not limited to, printed hardcopy, computer-generated hypertext, interactive animations, and/or synchronized graphic overlay with video.

13. The method of claim 9 further comprising the ability to generate trend analysis, using past and present performance quantification and derivative wagering models as determined by said system and method, to provide simulation results for handicapping purposes to plan and optimize future wagers.

14. The method of claim 9 further comprising the ability to set a user alert or user preference, such that the user can be paged or called back over a wireless communications device, with the live or requested data results formatted and customized for presentation over said device.
